(19) United States
(12) Patent Application Publication
(10) Pub. No.: US 2006/0090038 A1
(43) Pub. Date: Apr. 27, 2006

(54) Auto purge of serial use devices

(76) Inventors: Edward K.Y. Jung, Bellevue, WA (US); Royce A. Levien, Lexington, MA (US); Mark A. Malamud, Seattle, WA (US); John D. Rinaldo JR., Bellevue, WA (US)

Correspondence Address: Searete LLC, Suite 110, 1756 - 114th Ave. S.E., Bellevue, WA, 98004, US

(21) Appl. No.: 10/974,554

(22) Filed: Oct. 26, 2004

(51) Int. Cl. G06F 12/00

(52) U.S. Cl. 711/135

(57) ABSTRACT

Systems and devices having purging mechanisms.

### TECHNICAL FIELD

The present application relates, in general, to serial-use devices.

### SUMMARY

In one aspect, a method includes but is not limited to detecting that relinquishment of control of a serial-use device has likely occurred; and purging a memory of the serial-use device in response to said detecting. In addition to the foregoing, other method aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one or more various aspects, related systems include but are not limited to circuitry for detecting that relinquishment of control of a serial-use device has likely occurred; and circuitry for purging a memory of the serial-use device in response to said detecting. In addition to the foregoing, other system aspects are described in the claims, drawings, and text forming a part of the present application.

In one aspect, a system includes but is not limited to a serial-use device operably couplable with serial-user detection logic; and purgation logic operably-couplable with a memory device of said serial-use device. In addition to the foregoing, other system aspects are described in the claims, drawings, and text forming a part of the present application.

In addition to the foregoing, various other method and/or system aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the detailed description set forth herein.

### BRIEF DESCRIPTION OF THE FIGURES

FIG. 1 shows a high level block diagram of one implementation of serial-use device 100.

FIG. 2 depicts a high level block diagram of another implementation of serial-use device 100.

FIG. 3 illustrates a high level block diagram of another implementation of serial-use device 100.

FIG. 4 illustrates a high-level logic flowchart of a process.

FIG. 5 shows a high-level logic flowchart depicting alternate implementations of the high-level logic flowchart of FIG. 4.

FIG. 6 depicts a high level logic flowchart illustrating alternate implementations of the high level logic flowchart of FIG. 4.

The use of the same symbols in different drawings typically indicates similar or identical items.

### DETAILED DESCRIPTION

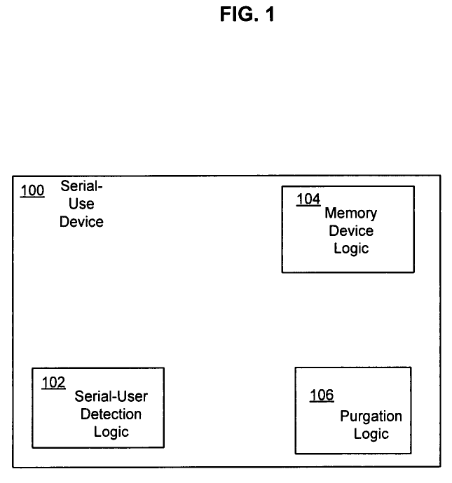

With reference to the figures, and with reference now to FIG. 1 shown is a high level block diagram of one implementation of serial-use device 100. Depicted is that serial-use device 100 contains memory device logic 104, serial-user detection logic 102, and purgation logic 106. In one implementation serial-user detection logic 102, memory device logic 104, and purgation logic 106 are at least partially formed from integrated circuits and are electrically interconnected (e.g., via conductors such as wires).

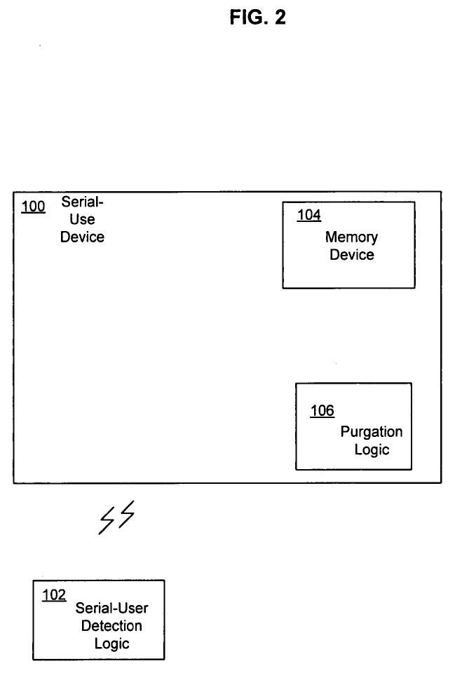

Referring now to FIG. 2, depicted is a high level block diagram of another implementation of serial-use device 100. In the implementation depicted, serial-user detection logic 102 is no longer resident within serial-use device 100, but is instead located at a position remote from serial-use device 100. For example, at a rental camera stand, such as might be utilized in an implementation where serial-use device 100 entails a digital camera ( e.g., still or motion). Illustrated is that serial-use device 100 and serial-user detection logic 102 are communicating via information exchanged across a distance. In one implementation such information can be exchanged wirelessly (e.g., via electromagnetic radiation). In another implementation such information can be exchanged optically (e.g. via electromagnetic radiation in the optical spectrum).

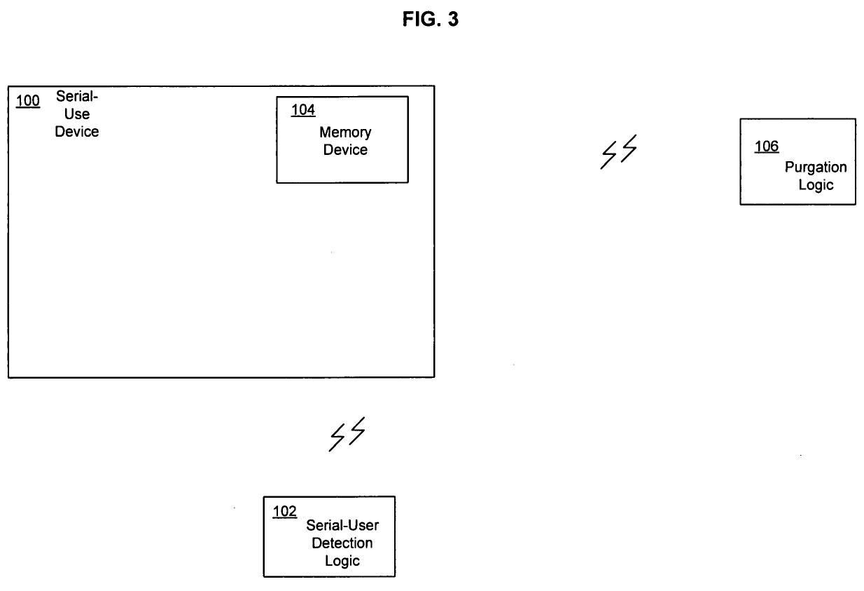

With reference now to FIG. 3, illustrated is a high level block diagram of another implementation of serial-use device 100. In the implementation shown, both serial-user detection logic 102 and purgation logic 106 are located at positions remote from serial-use device 100. For example, at a rental stand, such as might be utilized in an implementation where serial-use device 100 entails a computing device (e.g., a personal digital assistant (PDA), a blackberry, or a cell phone). Illustrated is that serial-use device 100 and serial-user detection logic 102, and purgation logic 106 are communicating via information exchanged across a distance. In one implementation such information can be exchanged wirelessly (e.g., via electromagnetic radiation). In another implementation such information can be exchanged optically (e.g., via electromagnetic radiation in the optical spectrum).

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations.

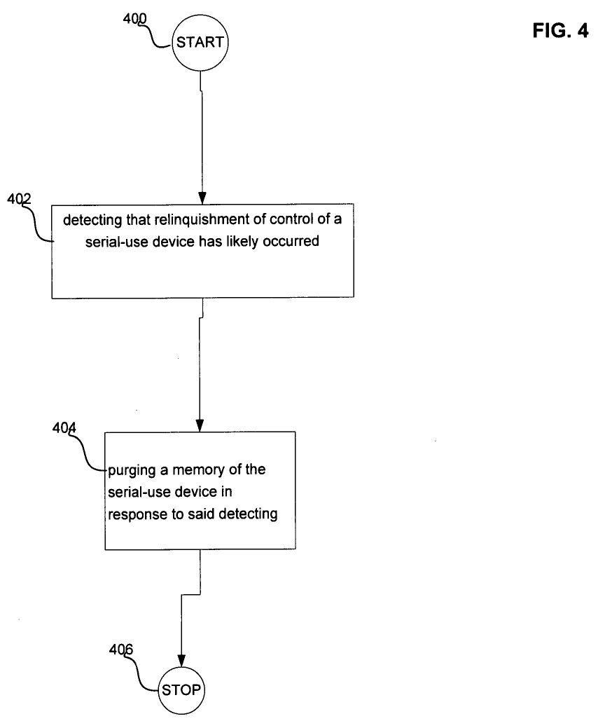

Referring now to FIG. 4, illustrated is a high-level logic flowchart of a process. Method step 400 shows the start of the process. Method step 402 shows detecting that relinquishment of control of a serial-use device has likely occurred (e.g., via serial-user detection logic 102 and/or its supporting components). Method step 404 depicts purging a memory of the serial-use device in response to said detecting (e.g., via purgation logic 106). Method step 406 shows the end of the process.

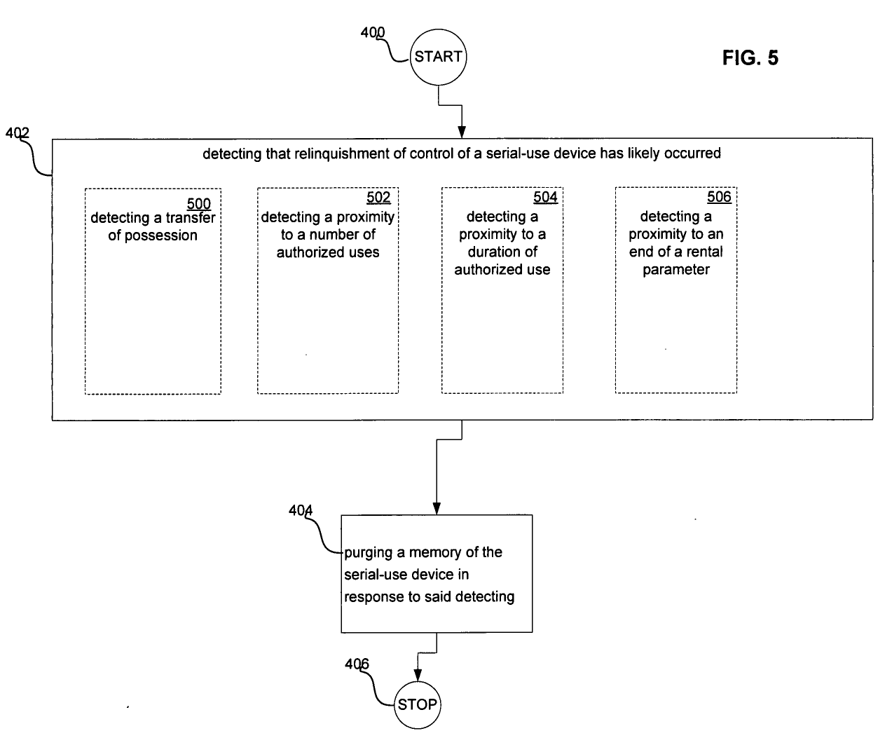

With reference now to FIG. 5, shown is a high-level logic flowchart depicting alternate implementations of the high-level logic flowchart of FIG. 4. Depicted is that. in various alternate implementations, method step 402 includes method step 500, and/or method step 502, and/or method step 504, and/or method step 506. Method step 500 shows detecting a transfer of possession (e.g., via serial-user detection logic 102 (a) communicating with a beacon in the return bin, such as might be used at a rental concern, to infer a proximity to a return bin; and/or (b) detecting that a different user now has serial-use device 100; and/or (c) detecting at least one instance of an unauthorized use). Method step 502 depicts detecting a proximity to a number of authorized uses (e.g., detecting that a number of authorized uses have been or are about to be performed via serial-user detection logic 102 tracking a number of uses of serial-use device 100 and comparing such tracked number of uses against a known authorized number of uses). Method step 504 illustrates detecting a proximity to a duration of authorized use (e.g., detecting that a duration of authorized use has expired and/or will expire via serial-user detection logic 102 tracking an elapsed time since serial-use device 100 left a rental facility and comparing such tracked elapsed time against a known authorized duration of time). Method step 506 illustrates detecting a proximity to an end of a rental parameter (e.g., detecting that one or more of any number of rental parameters are at or near their respective ends via serial-user detection logic 102 tracking such one or more rental parameters in an appropriate fashion).

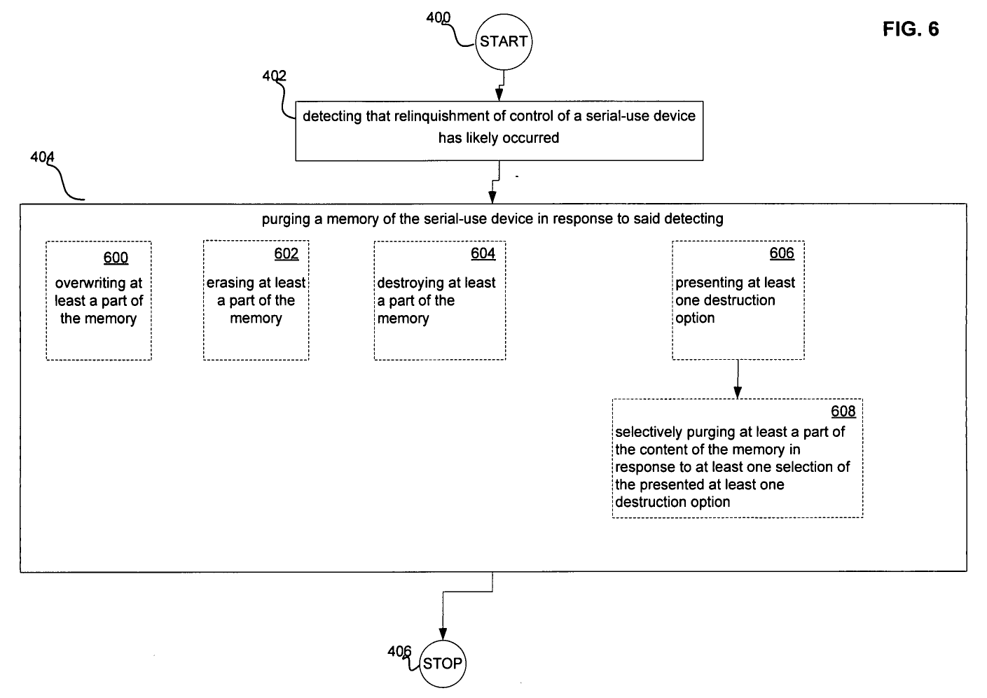

Referring now to FIG. 6, depicted is a high level logic flowchart illustrating alternate implementations of the high level logic flowchart of FIG. 4. Shown is that in various alternate implementations, method step 404 includes method step 600, and/or method step 602, and/or method step 604. Method step 600 depicts overwriting at least a part of the memory (e.g., via purgation device 106 overwriting all or part of memory storage available in memory device logic 104, such as by replacing the data with pseudo-random bits and/or a token pattern that indicates that at one point the deleted data was present (e.g., deleted data was of photo of 04 April 2004)). Method step 602 illustrates erasing at least a part of the memory (e.g., via purgation logic 106 erasing all or part of memory storage available in memory device logic 104). Method step 604 illustrates destroying at least a part of the memory (e.g., via purgation logic 106 burning all or part of the circuitry of memory device logic 104). Method step 606 shows presenting at least one destruction option (e.g., via purgation logic 106 presenting to the user one or more purging options (e.g., to purge all or only a part of the content of the memory, such as, for example, only a select digital photograph, and/or digital video, and/or digital audio) through a device accessible by a human/robotic user, such as a Radio Frequency Identification (RFID) dog tag, a swinging Bluetooth medallion, a wristwatch, a presentation mechanism of serial use device 100 (e.g., liquid crystal display, text output, voice output, etc.) Method step 608 depicts selectively purging at least a part of the content of the memory in response to at least one selection of the presented at least one destruction option (e.g., via purgation logic 106 transmitting the selected content via ways described/illustrated elsewhere herein and/or over a personal area network (PAN) using some appropriate technology such as ultra wide band (UWB) in response to a human/robotic selection of a destruction option).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; altematively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same ftunctionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. A method comprising:
detecting that relinquishment of control of a serial-use device has likely occurred; and purging a memory of the serial-use device in response to said detecting.

2. The method of claim 1, wherein said detecting that relinquishment of control of a serial-use device has likely occurred further comprises:
detecting a transfer of possession.

3. The method of claim 1, wherein said detecting that relinquishment of control of a serial-use device has likely occurred further comprises:
detecting a proximity to a number of authorized uses.

4. The method of claim 1, wherein said detecting that relinquishment of control of a serial-use device has likely occurred further comprises:
detecting a proximity to a duration of authorized use.

5. The method of claim 1, wherein said detecting that relinquishment of control of a serial-use device has likely occurred further comprises:
detecting a proximity to an end of a rental parameter.

6. The method of claim 1, wherein said purging a memory of the serial-use device in response to said detecting further comprises:
overwriting at least a part of the memory.

7. The method of claim 1, wherein said purging a memory of the serial-use device in response to said detecting further comprises:
erasing at least a part of the memory.

8. The method of claim 1, wherein said purging a memory of the serial-use device in response to said detecting further comprises:
destroying at least a part of the memory.

9. The method of claim 1, wherein said purging a memory of the serial-use device in response to said detecting further comprises:
presenting at least one destruction option; and
selectively purging at least a part of the content of the memory in response to at least one
selection of the presented at least one destruction option.

10. A system comprising:
means for detecting that relinquishment of control of a serial-use device has likely occurred; and
means for purging a memory of the serial-use device in response to said detecting.

11. The system of claim 10, wherein said means for detecting that relinquishment of control of a serial-use device has likely occurred further comprises:
means for detecting a transfer of possession.

12. The system of claim 10, wherein said means for detecting that relinquishment of control of a serial-use device has likely occurred further comprises:
means for detecting a proximity to a number of authorized uses.

13. The system of claim 10, wherein said means for detecting that relinquishment of control of a serial-use device has likely occurred further comprises:
means for detecting a proximity to a duration of authorized use.

14. The system of claim 10, wherein said means for purging a memory of the serial-use device in response to said detecting further comprises:
means for overwriting at least a part of the memory.

15. The system of claim 10, wherein said means for purging a memory of the serial-use device in response to said detecting further comprises:
means for erasing at least a part of the memory.

16. The system of claim 10, wherein said means for purging a memory of the serial-use device in response to said detecting further comprises:
means for destroying at least a part of the memory.

17. The system of claim 10, wherein said means for purging a memory of the serial-use device in response to said detecting further comprises:
means for presenting at least one destruction option; and
means for selectively purging at least a part of the content of the memory in response to at least one selection of the presented at least one destruction option.

18. A system comprising:
circuitry for detecting that relinquishment of control of a serial-use device has likely occurred; and
circuitry for purging a memory of the serial-use device in response to said detecting.

19. A system comprising:
a serial-use device operably couplable with serial-user detection logic; and
purgation logic operably-couplable with a memory device of said serial-use device.

20. The system of claim 19, wherein said serial-use device operably couplable with serial-user detection logic further comprises:
said serial-use device electrically couplable with said serial-user detection logic.

21. The system of claim 19, wherein said serial-use device operably couplable with serial-user detection logic further comprises:
said serial-use device optically couplable with said serial-user detection logic.

22. The system of claim 19, wherein said serial-use device operably couplable with serial-user detection logic further comprises:
said serial-use device wirelessly couplable with said serial-user detection logic.

23. The system of claim 19, wherein said purgation logic operably-couplable with a memory device of said serial-use device further comprises:
the memory device of said serial-use device electrically couplable with said purgation logic.

24. The system of claim 19, wherein said purgation logic operably-couplable with a memory device of said serial-use device further comprises:
the memory device of said serial-use device optically couplable with said purgation logic.

25. The system of claim 19, wherein said purgation logic operably-couplable with a memory device of said serial-use device further comprises:
the memory device of said serial-use device wirelessly couplable with said purgation logic.

26. The system of claim 19, wherein said serial-use device further comprises:
at least one of a still image device, a motion image device, a textual data device, or an audio device.
